(19) United States
(12) Patent Application Publication
(10) Pub. No.: US 2013/0321433 A1
(43) Pub. Date: Dec. 5, 2013

(54) FRONTLIGHT DEVICE WITH INTEGRATED ELECTRICAL WIRING

(71) Applicants: Ion Bita, San Jose, CA (US); Russel A. Martin, San Jose, CA (US); Marek Mienko, San Jose, CA (US); Jyotindra R. Shakya, Sunnyvale, CA (US)

(72) Inventors: Ion Bita, San Jose, CA (US); Russel A. Martin, San Jose, CA (US); Marek Mienko, San Jose, CA (US); Jyotindra R. Shakya, Sunnyvale, CA (US)

(73) Assignee: QUALCOMM MEMS Technologies, Inc., San Diego, CA (US)

(21) Appl. No.: 13/605,731

(22) Filed: Sep. 6, 2012

Related U.S. Application Data
(60) Provisional application No. 61/654,012, filed on May 31, 2012.

(51) Int. Cl. G06T 1/00; G02B 6/00; G02B 26/00; H01J 9/20

(52) U.S. Cl. 345/501; 445/24; 385/122; 359/291

(57) ABSTRACT

This disclosure provides systems, methods, and apparatus related to a the design of arrays of electrodes in a device which includes a light-guiding layer in optical contact with the electrodes. In one aspect, a device includes an array of electrodes, the electrodes include at least one edge having a non-linear shape. Specific design constraints may be placed on the shape of the non-linear edge of the electrodes.

### CROSS-REFERENCE TO RELATED APPLICATIONS

This patent application claims priority to U.S. Provisional Patent Application No. 61/654,012 filed May 31, 2012 and entitled “FRONTLIGHT DEVICE WITH INTEGRATED ELECTRICAL WIRING,” and assigned to the assignee hereof. The disclosure of the prior application is considered part of and is incorporated by reference in this patent application.

### TECHNICAL FIELD

This disclosure relates to electrode arrays in display devices including a light-guiding layer, such as front-lit display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in a device, comprising a light-guiding layer, wherein the light-guiding layer is configured to constrain light propagating therein; and a plurality of electrodes in optical contact with the light-guiding layer, wherein the plurality of electrodes include at least one edge having a non-linear shape.

In one aspect, one of the plurality of electrodes can extend from a first point to a second point, wherein the length of the at least one edge having a non-linear shape is longer than the distance between the first point and the second point. In one aspect, the at least one edge having a non-linear shape can comprise a non-zero curvature along at least 90% of the length of the edge, or along at least 95% of the length of the edge. In one aspect, the length of the at least one edge having a non-linear shape can be at least 25% longer than the distance between the first point and the second point.

In one aspect, the distance between the first point to the second point can be given by L; the one of the plurality of electrodes can have an average width W over its length; and the total area of the one of the plurality of electrodes can be less than twice the product of L and W. In a further aspect, the total area of the one of the plurality of electrodes can be less than 1.5 times the product of L and W.

In one aspect, the non-linear edge can have a characteristic dimension given by D indicative of the shape of the plurality of electrodes; at least one of the plurality of electrodes can have an average width over its length given by W; and the ratio D/W can be selected to be less than 20. In a further aspect, the ratio D/W can be selected to be less than 5. In a further aspect, the non-linear edge can include a plurality of semicircular arcs, where the characteristic dimension D is the outer diameter of the semicircular arcs. In one aspect, the non-linear edge includes an oscillating shape can include a plurality of peaks, where the characteristic dimension D is the average distance between peaks.

In one aspect the width of the plurality of electrodes can remain substantially constant along their lengths. In one aspect, the width of the plurality of electrodes can vary along their lengths. In one aspect, the plurality of electrodes can also include at least a second edge having a non-linear shape. In a further aspect, the first and second edges can extend substantially parallel to one another.

In one aspect, the at least one edge having a non-linear shape can include a substantially periodic shape. In one aspect, the plurality of electrodes can include an absorber layer, a spacer layer disposed between the absorber layer and the light-guiding layer, and a reflective layer disposed between the spacer layer and the light-guiding layer.

In one aspect, the device can additionally include a reflective display disposed on the opposite side of the light-guiding layer as the plurality of electrodes, wherein the light-guiding film includes light-turning features configured to redirect light propagating within the light-guiding layer towards the reflective display. In a further aspect, the reflective display can include a plurality of display elements and the non-linear edge can include an oscillating shape comprising a plurality of peaks, wherein a characteristic dimension D is defined as the average distance between peaks, and wherein the characteristic dimension D is substantially equal to or less than a width of one of the plurality of display elements.

Another innovative aspect of the subject matter described in this disclosure can be implemented in a device, comprising a light-guiding layer, wherein the light-guiding layer is configured to constrain light propagating therein; and a plurality of electrodes in optical contact with the light-guiding layer, wherein the plurality of electrodes include means for minimizing undesirable optical effects when light is propagating within the light-guiding layer.

In one aspect, the minimizing means can include at least one edge having a non-linear shape.

Another innovative aspect of the subject matter described in this disclosure can be implemented in a method of fabricating a device, comprising: forming a plurality of electrodes on a substrate, wherein the plurality of electrodes include at least one edge having a non-linear shape; providing a light-guiding layer configured to constrain light propagating therein; and placing the plurality of electrodes in optical communication with the light-guiding layer.

In one aspect, forming a plurality of electrodes on a substrate and placing the plurality of electrodes in optical communication with the light-guiding layer can include forming at least a portion of the plurality of electrodes on a surface of the light-guiding layer. In one aspect, one of the plurality of electrodes can extend from a first point to a second point, wherein the length of the at least one edge having a non-linear shape is longer than the distance between the first point and the second point. In one aspect, the distance between the first point to the second point can be given by L; the one of the plurality of electrodes can have an average width W over its length; and the total area of the one of the plurality of electrodes can be less than twice the product of L and W.

In one aspect, the non-linear edge can have a characteristic dimension given by D indicative of the shape of the plurality of electrodes; at least one of the plurality of electrodes can have an average width over its length given by W; and the ratio D/W can be selected to be less than 20. In a further aspect, the ratio D/W can be selected to be less than 5.

Another innovative aspect of the subject matter described in this disclosure can be implemented in a method of fabricating a device, comprising: forming a plurality of jumper portions on a surface of a first light-guiding layer; disposing a second light-guiding sublayer over the first light-guiding sublayer, wherein the second light-guiding sublayer includes a plurality of tapered apertures extending therethrough, and wherein at least a first portion of the tapered apertures expose a portion of an underlying jumper portion, depositing at least one layer over the second light-guiding layer; and patterning the at least one layer to form a plurality of electrodes at least partially disposed on the surface of the patterned second light-guiding layer, wherein the plurality of electrodes include at least one edge having a non-linear shape.

In one aspect, disposing a second light-guiding sublayer over the first light-guiding sublayer can include forming a second light-guiding sublayer over the first light-guiding sublayer and patterning the second-light guiding layer to form a plurality of tapered apertures in the second-light guiding layer. In one aspect, a second portion of the tapered apertures formed in the second light-guiding layer can not expose a portion of an underlying jumper portion, wherein patterning the at least one layer to form a plurality of electrodes can further include patterning the at least one layer to form a plurality of light-turning features at least partially disposed within the second portion of the tapered apertures.

In one aspect, depositing at least one layer over the patterned second light-guiding layer can include depositing a stack of layers over the patterned second light-guiding layer, the stack of layers including a reflective layer, depositing a spacer layer over the reflective layer, and depositing an absorber layer over the spacer layer. In one aspect, the jumper portions can be substantially linear.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a diagram of a projected capacitive touch (PCT) sensor.

FIG. 2 shows an example of a circuit diagram of the PCT sensor of FIG. 1.

FIG. 3 shows an example of a diagram of a PCT sensor having row electrodes that are partially coplanar and partially non-coplanar with column electrodes.

FIG. 4A shows a top view of an example of an intersection of a PCT sensor with light shielding structures coupled to the row electrode.

FIG. 4B shows a cross-sectional view of the intersection of the PCT sensor of FIG. 4A taken along line 4B-4B.

FIG. 4C shows a top perspective view of the intersection of the PCT sensor of FIG. 4A.

FIG. 4D shows a cross-sectional view of the PCT sensor of FIG. 4A taken along line 4D-4D.

FIG. 5 shows a cross-sectional view of an example of a display device including a PCT sensor and a light-guiding film in optical contact with the components of the PCT sensor.

FIG. 6A shows examples of multiple non-linear electrode shapes which may be used in a PCT sensor in optical contact with a light-guiding film.

FIG. 6B shows an example of a comparison between a non-linear electrode shape and a similarly dimensioned linear electrode shape.

FIG. 7A shows a top view of an example of an intersection of a PCT sensor utilizing non-linear electrodes.

FIG. 7B shows a top perspective view of the intersection of the PCT sensor of FIG. 7A.

FIG. 8 shows an example of a flow diagram illustrating a manufacturing process for a device including a plurality of electrodes with at least one non-linear edge

FIG. 9 is an isometric view illustration depicting two adjacent interferometric modulator (IMOD) display elements in a series or array of display elements of an IMOD display device.

FIG. 10 is a system block diagram illustrating an electronic device incorporating an IMOD-based display including a three element by three element array of IMOD display elements.

FIGS. 11A and 11B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A touchscreen can detect the presence and location of a finger or stylus touch within a display area enabling user input and interaction with visual information in the display area. In some implementations, a touchscreen can include a projected capacitive touch (PCT) sensor arranged over a display. The PCT sensor can include an array of capacitors formed by a number of sensor electrodes in the form of overlapping electrodes, such as row electrodes and column electrodes that are arranged in a grid pattern. The sensor electrodes can be coplanar but may include overlapping regions by passing over or under one another at intersections or junctions between, e.g., a row electrode and a column electrode. In some display devices, a light-guiding layer can be used to constrain light propagating within the light-guiding layer, such as in a frontlight system in which the light-guiding layer includes light-turning features configured to eject light from the light-guiding layer in a desired direction and at a desired angle. When the light-guiding layer is in optical contact with an array of electrodes in a PCT sensor or similar component, an array of linearly-extending electrodes may interact with the light propagating within the light-guiding layer to create an optical effect which is generally undesirable in a display device or similar device. By utilizing electrodes that have a shape which is at least partially non-linear, this optical effect can be avoided.

Particular implementations of the subject matter described in this disclosure can be implemented to realize one or more of the following potential advantages. If a measure of the nonlinearity of the electrode shape is constrained within or close to a particular range, nonlinear electrodes can be provided which cause only a minimal increase in the overall area of the electrodes. By minimizing the increase in electrode area, the overall effect on the brightness and appearance of a display can be minimal, while still avoiding the undesirable optical effects resulting from the presence of linear electrodes.

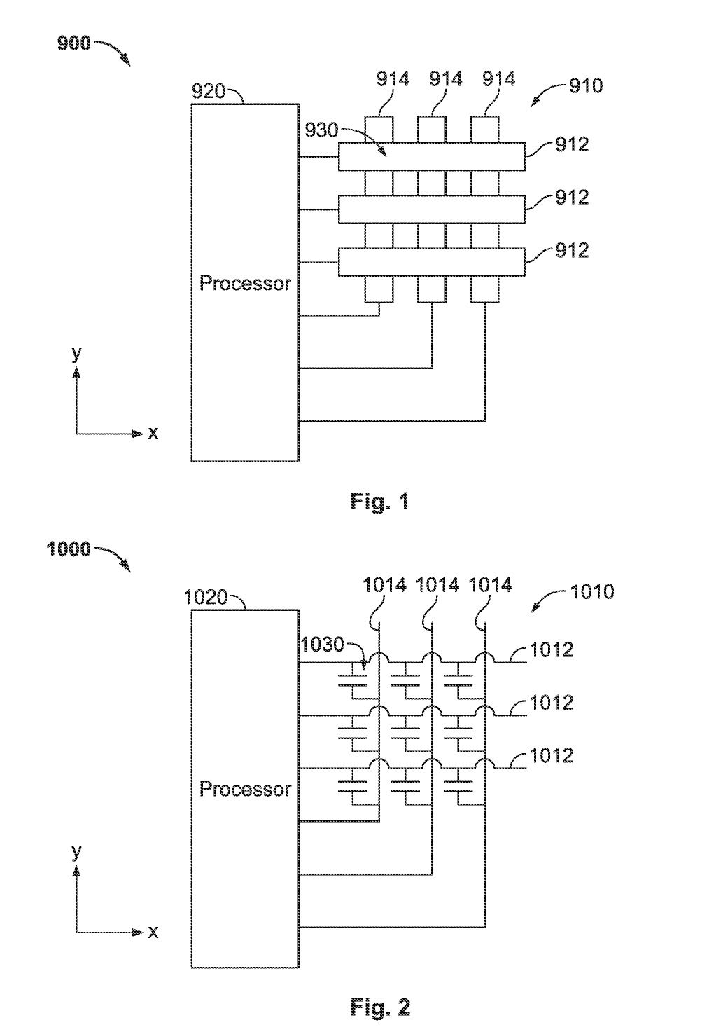

To assist in the description of the features described below with reference to FIGS. 1-7B, the following Cartesian coordinate terms are used, consistent with the coordinate axes illustrated in FIGS. 1-7B. An “x-axis” extends perpendicular to a “y-axis” and a “z-axis.” The y-axis and the z-axis extend perpendicular to each other. Thus, the z-axis is orthogonal to a plane formed by the x-axis and the y-axis. Further, although structures disclosed herein, e.g., row electrodes, column electrodes, and/or light shielding structures, may be generally described as “coplanar” with respect to other structures, and/or non-coplanar with respect to other structures, it will be understood that these structures may themselves be contoured. As such, references to non-coplanar structures will be understood to mean that these structures are transversely offset or spaced apart from one another to allow for electrical isolation.

FIG. 1 shows an example of a diagram of a projected capacitive touch (PCT) sensor 900. The sensor 900 may be placed over a display panel or display device to form a touchscreen. As discussed above, a touchscreen can detect the presence and location of a touch within a display area of the display device. In some implementations, the sensor 900 includes a number of sensor electrodes, namely, a number of row electrodes 912 and a number of column electrodes 914. The row electrodes 912 are positioned over and generally perpendicular to the column electrodes 914 to form a capacitor grid 910. As illustrated, the row electrodes 912 can form line segments that extend parallel to one another. That is to say, the row electrodes 912 can extend in a substantially linear direction. Similarly, the column electrodes 914 can also extend in a substantially linear direction generally perpendicular to the row electrodes 912 forming an array or grid. In some implementations, at least a portion of the row electrodes 912 can extend underneath the column electrodes 914 to form the capacitor grid 910. The row electrodes 912 and the column electrodes 914 can include various conductive materials including, for example, transparent conductive oxides and non-transparent reflective metals. In some implementations, the row electrodes 912 and the column electrodes 914 can include the same materials. In other implementations, the row electrodes 912 and the column electrodes 914 can include different materials.

In some implementations, each of the row electrodes 912 and column electrodes 914 are coupled to a processor 920. The processor 920 can be configured to apply a voltage to the row electrodes 912 and to measure a voltage at the column electrodes 914 or vice versa. A location where a portion of the row electrodes 912 overlaps (e.g., by passing above or below) a portion of the column electrodes 914 can be referred to as an intersection or junction 930. The row electrodes 912 are at least partially offset along the z-axis (out of the page) from the column electrodes 914 at least at intersections 930. Stated differently, at least a portion of the row electrodes 912 is formed on a first plane that extends parallel to the x-y plane, the column electrodes 914 are formed on a second plane that extends parallel to the x-y plane, and the first plane and the second plane are offset or spaced apart from one another. Thus, at least a portion of the row electrodes 912 and the column electrodes 914 can be formed during separate thin film deposition processes, resulting in the portion of the row electrodes 912 and the column electrodes 914 being on different planes. For example, the row electrodes 912 can be disposed at least partially above the column electrodes 914 as schematically depicted in FIG. 1.

Due to this configuration, the row electrodes 912 and the column electrodes 914 do not touch or contact one another at the intersections 930. Thus, the row electrodes 912 and the column electrodes 914 can at least partially overlap to form capacitors at the intersections 930. In some implementations, such an insulating layer can be substantially transparent and/or light transmissive to allow visible light to pass therethrough. As discussed in further detail below, an insulating layer can be disposed between the column electrodes 914 and the row electrodes 912 to maintain an insulating space therebetween, electrically isolating the row electrodes 912 from the column electrodes 914. In some implementations, the insulating layer can serve as a supporting substrate or film for one of the sets of electrodes, which can then be coupled with the substrate supporting the other set of electrodes to form a capacitive array.

When a conductive input device, such as stylus or a finger, is brought close to one or more of the intersections 930, the electrostatic field at those locations is changed altering the capacitance of the capacitors formed at the intersections 930. The capacitance change at each of the intersections 930 can be measured by the row electrodes 912, the column electrodes 914, and the processor 920. Further, the processor 920 can determine the touch location or multiple touch locations based on the measured capacitance changes.

FIG. 2 shows an example of a circuit diagram 1000 of the PCT sensor 900 of FIG. 1. The circuit diagram 1000 illustrates a capacitor grid 1010 having a number of row leads 1012 and column leads 1014 coupled to a processor 1020. The processor 1020 can be configured to apply a voltage to the row leads 1012 and measure a voltage at the column leads 1014 or vice versa. The capacitor grid 1010 includes a two-dimensional array of capacitors 1030, each formed by overlapping portions of one of the row leads 1012 and one of the column leads 1014 such as the intersections 930 of FIG. 1.

As mentioned above with respect to FIG. 1, at least a portion of the row leads 1012 are spaced apart along the z-axis (out of the page) from the column leads 1014. However, in some implementations, other portions of the row leads 1012 may be coplanar with, or formed on the same plane or level as, the column leads 1014. These portions may be connected with jumpers or interconnects which are not coplanar with the column leads 1014 in order to cross over the column leads 1014 while remaining electrically isolated from them.

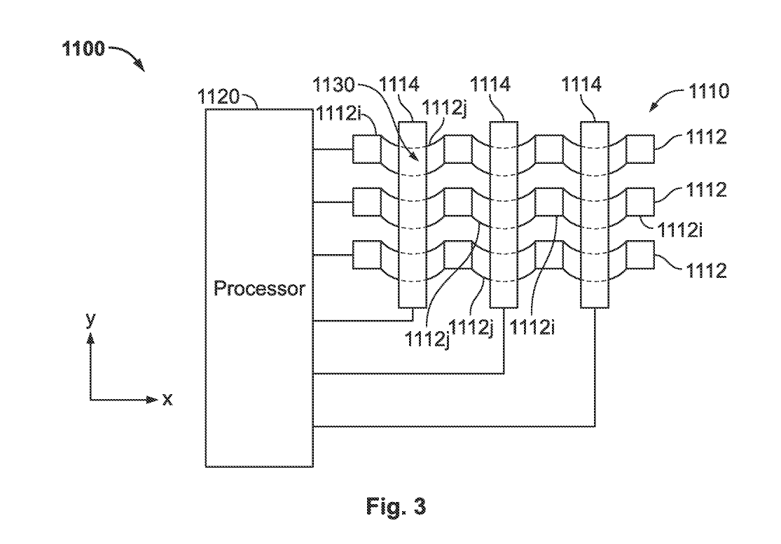

FIG. 3 shows an example of a diagram of a PCT sensor 1100 having row electrodes 1112 that are partially coplanar and partially non-coplanar with column electrodes 1114. Like the sensor 900 of FIG. 1, the sensor 1100 includes a capacitor grid 1110 formed from row electrodes 1112 which are positioned under, and extend generally perpendicular to, column electrodes 1114. Each of the row electrodes 1112 and column electrodes 1114 are coupled to a processor 1120.

The row electrodes 1112 include coplanar portions 1112i and jumper portions 1112j. In the illustrated implementation, the coplanar portions 1112i are coplanar with one another and also generally coplanar with the column electrodes 1114. In contrast, the jumper portions 1112j are non-coplanar or spaced apart along the z-axis (out of the page) from the column electrodes 1114 at least at intersections 1130, such that the overlapping portions of the jumper portions 1112j and the column electrodes 1114 form capacitors at intersections 1130.

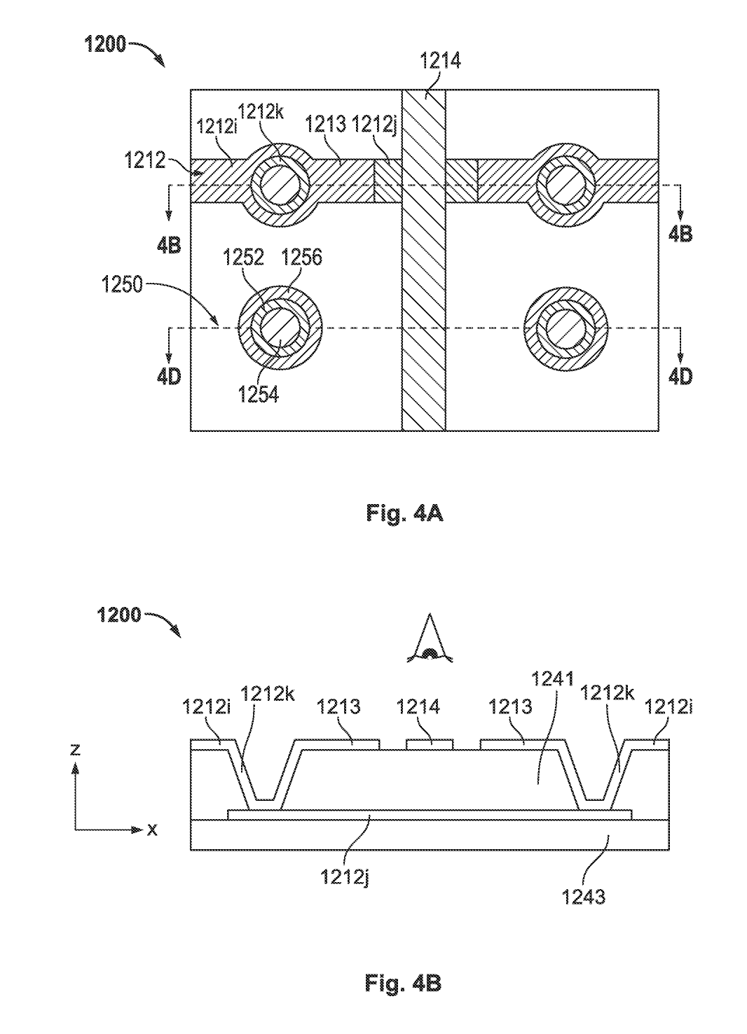

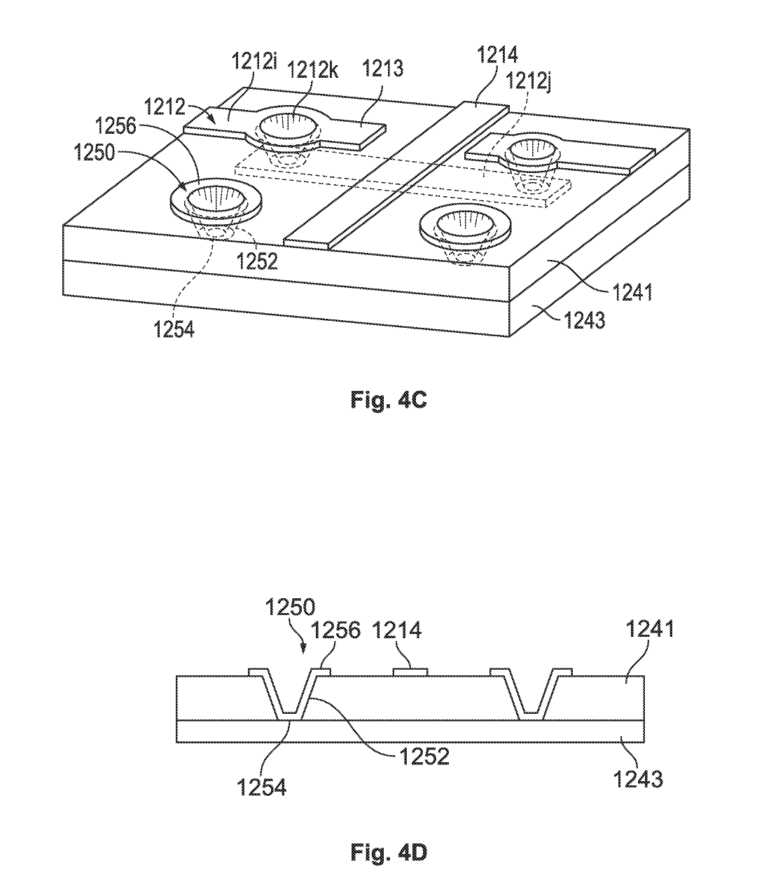

Although FIG. 3 generally shows the jumper portions 1112j as arcuate-shaped curves (e.g., rainbow-shaped curves), other configurations are possible. For instance, the jumper portions 1112j may be U-shaped or staple-shaped. The shape and/or configuration of the jumper portions 1112j may be dictated at least in part by the manufacturing process(es) used to form the PCT sensor 1110. In some implementations, such as the implementations described below with respect to FIGS. 4A-4D and similar structures, the jumper portion 1112j may include a generally planar jumper portion 1312j, 1412j, 1512j, coupled to the row electrode by vias or connector portions.

In an implementation in which the column electrodes 1114 and the coplanar portions 1112i of the row electrodes 1112 extend along a common plane, they may advantageously in some implementations be formed at the same time, from the same materials, and/or using the same processes thereby effectuating time and cost savings. The jumper portions 1112j may be formed of any conductive materials. For example, in some implementations, the jumper portions 1112j are metal. However, the metallic appearance of the jumper portions 1112j may be disadvantageous as it may reflect incident light back to a viewer, causing undesirable optical effects. Thus, in some implementations, the jumper portions 1112j are made from a transparent conductive material, such as indium tin oxide (TTO), zinc oxide (ZnO), indium gallium zinc oxide (InGaZnO), etc. In another implementation, the jumper portions 1112j are formed of an interferometric stack that absorbs visible light.

As mentioned above, jumper portions may form part of a row electrode (e.g., a non-planar portion of the row electrode) and serve to interconnect other portions of the row electrode (e.g., coplanar portions of the row electrode on either side of the jumper portion) to prevent electrical coupling of the column electrode and the coplanar portions of the row electrode. Thus, jumper portions can form part of a capacitive sensor electrode (e.g., a row electrode or a column electrode). In some implementations, light shielding structures are formed which overlap the jumper portions and substantially obstruct such jumper portions from the view of a user, allowing the use of a reflective jumper portions, e.g., metallic jumper portions, while reducing the undesirable optical effects resulting from reflections of visible light from the reflective jumper portions. In further implementations, these light shielding structures may be coplanar with either or both of a column electrode or portions of a row electrode.

FIG. 4A shows a top view of an example of an intersection of a PCT sensor 1200 with light shielding structures 1213 coupled to the row electrode 1212. FIG. 4B shows a cross-sectional view of the intersection of the PCT sensor 1200 of FIG. 4A taken along line 4B-4B. FIG. 4C shows a top perspective view of the intersection of the PCT sensor 1200 of FIG. 4A. FIG. 4D shows a cross-sectional view of the PCT sensor 1200 of FIG. 4A taken along line 4D-4D extending through the light turning features 1250. The sensor 1200 is substantially similar to the sensor 1100 of FIG. 3, but differs in that it includes light shielding structures 1213 which overlie, overlap, or cover at least a portion of underlying jumper portions 1212j. In other words, at least a portion of a light shielding structure 1213 is transversely offset along the z-axis from at least a portion of a jumper portion 1212j, such that it is disposed over at least the portion of the jumper portion 1212j. The light shielding structures 1213 are configured to absorb visible light incident thereon and/or interferometrically modulate light incident thereon to reflect non-visible wavelengths. In some implementations, the light shielding structures 1213 can include an interferometric stack, e.g., an interferometric black mask. In some implementations, the light shielding structures 1213 can include an absorber, e.g., a black coating and/or layer of absorptive material. In this way, the light shielding structures 1213 can reflect less visible light than reflective structures or materials such as reflective jumper portions 1212j and in some implementations may reflect little or no visible light. In some implementations, the light shielding structures 1213 can be at least partially transparent, e.g., configured to shield or absorb some but not all incident light, and in other implementations, the light shielding structures 1213 can be opaque.

As shown in FIGS. 4B and 4C, coplanar portions 1212i of the row electrode 1212 may be disposed over an insulating layer 1241—such as a dedicated dielectric layer or an insulating layer of another component of the display device, as discussed in greater detail below—and lie coplanar with the column electrode 1214. The jumper portions 1212j may be disposed over or formed on an underlying substrate layer 1243 that is disposed beneath the insulating layer 1241. Thus, the jumper portions 1212j can be non-coplanar with the coplanar portions 1212i of the row electrodes 1212 and the column electrodes 1214.

The coplanar portions 1212i are electrically connected with the jumper portions 1212j by connection portions 1212k, which in the illustrated implementation take the form of rounded vias having an inverted frustroconical shape. In some implementations, the connection portions 1212k can be integral or homogeneous with the jumper portions 1212j. Thus, the jumper portions 1212j and the connection portions 1212k can collectively be considered to be non-coplanar portions of the row electrode 1212 because these portions do not lie on the same plane as the coplanar portions 1212i of the row electrode 1212 or the column electrode 1214. Additionally, the light shielding structures 1213 are disposed over the jumper portions 1212j between the connection portions 1212k and the column electrode 1214. In some implementations, the light shielding structures 1213 are coplanar with the column electrode 1214 and the coplanar portions 1212i of the row electrodes 1212. Thus, as shown in FIG. 4A, the light shielding structures 1213 at least partially shield, hide, and/or obstruct the jumper portion 1212j from the view of a user looking at the sensor 1200 from above.

As schematically illustrated in FIG. 4A, the appearance of the light shielding structures 1213 may be similar to the appearances of the column electrode 1214, the connection portions 1212k, and the coplanar portions 1212i of the row electrodes 1212. In other words, the light shielding structures 1213, the column electrode 1214, the connection portions 1212k, and the coplanar portions 1212i of the row electrodes 1212 may each reflect a similar amount of visible light. In some implementations, the column electrode 1214, the connection portions 1212k, the coplanar portions 1212i of the row electrodes 1212, and the light shielding structures 1213 are similarly formed and configured to absorb visible light incident thereon and/or interferometrically modulate light incident thereon to reflect non-visible wavelengths.

In one particular implementation, these structures may be formed from a stack of layers including a reflective layer on the side of the stack facing the layer 1241, an absorber layer overlying the reflective layer, and a spacer layer between the reflective layer and the absorber layer, such that the absorber layer, spacer layer, and reflective layer together define a dark etalon which is configured to reflect a minimal amount of light back towards a viewer on the absorber side of the stack.

In some implementations, the reflective layer may comprise aluminum or an aluminum-containing alloy such as an aluminum-copper (AlCu), aluminum-silicon (AlSi), or aluminum-neodymium (AlNd) alloy or other appropriate alloy. The spacer layer may comprise, for example, a silicon dioxide (SiO₂) layer, and the absorber layer may comprise a molybdenum-chromium (MoCr) alloy. The reflective layer may also serve as the primary conductor in the electrode 1214 and electrode portions 1212i and 1212k, while the upper layers may serve as a masking structure which cooperates with the reflective layer to form a dark etalon. In some implementations, an additional SiO₂ layer may be formed over the absorber layer to further improve the optical properties of the stack by further inhibiting reflection off of the upper surface of the stack towards a viewer.

As also shown in FIG. 4C, in some implementations the connection portions 1212k may be conformally deposited over a tapered aperture or depression having an inverted frustroconical shape formed in the insulating layer 1241 to interconnect the jumper portions 1212j with the coplanar portions 1212i. Alternatively, in some implementations, the connection portions 1212k may include plugs or vias of other shapes extending between the jumper portions 1212j and the coplanar portions 1212i. Such plugs or vias may include an overlying mask configured to absorb visible light incident thereon and/or interferometrically modulate light incident thereon to reflect non-visible wavelengths.

In an implementation in which the insulating layer 1241 forms a portion of a light-guiding layer, the inverted frustroconical tapered apertures formed in the layer 1241 may also be formed at locations away from jumper portions 1212j. Sections of the same layer or layers which are used to form the electrode 1214 and the coplanar portions 1212i and the connection portions 1212k of electrode 1212 may be deposited over other apertures within the layer 1241 to form light-turning features 1250. These light-turning features 1250 may include a tapered sidewall 1252 oriented at an angle to the upper surface of layer 1241 and a base 1254. In the illustrated implementation, the tapered sidewall 1251 has a frustroconical shape terminating in a substantially circular base 1254, although other shapes may be used. To ensure complete coverage of the tapered sidewall of the aperture, the deposited or layers may be patterned to leave an outwardly extending lip 1256 over the upper surface of layer 1241, such that the overall diameter of the light-turning feature 1250 is larger than the diameter of the frustroconical reflective surface defined by sidewall 1252.

As can be seen in FIG. 4D, the cross-sectional shape of the light-turning features 1250 is similar to the cross-sectional shape of the circular vias which form connection portions 1212k and the immediately adjacent portions of the coplanar electrode portion 1212i (see FIG. 4B). The tapered sidewall 1252 of light-turning feature (as well as the connection portion 1212k of FIG. 4B) make an angle with the upper surface of the layer 1241 which controls the direction at which the light-turning features 1250 reflect light. In some implementations, this angle is between 30° and 60°, while in other implementations the angle is between 40° and 50°. The particular angle chosen may depend, for example, on the indices of refraction and thicknesses of other layers through which the reflected light will pass before exiting the device towards a viewer.

The light shielding structures 1213 shown in FIGS. 4A-4C as extending from the connection portions 1212k of the row electrodes 1212 so as to be coplanar with the column electrode 1214 and the coplanar portions 1212i of the row electrodes 1212. However, in other implementations, the shielding portions 1213 may extend from the column electrodes 1214 or may be separate structures. In still other implementations, no shielding portions 1213 may be provided.

A PCT sensor such as the PCT sensors of FIGS. 1-4C may be used in a reflective display device such as an interferometric modulator display, the operation of which is discussed in greater detail below. Supplemental illumination of such a reflective display may be provided through the use of a frontlight system, which may include a light-guiding layer into which light can be injected, and light-turning features configured to reflect light within the light-guiding layer towards the reflective display and back through the light-guiding layer towards a viewer. Until light reaches a light-turning feature, the injected light may propagate within the light guiding layer by means of total internal reflection due to selection of a material for the light-guiding layer which has an index of refraction greater than that of the surrounding layers.

In order to minimize the thickness of the display, at least one set of electrodes may in some implementations be disposed on a surface of or within a light-guiding layer of a frontlight film. In other implementations, a set of electrodes may not be directly adjacent or in contact with the light-guiding film, but may nevertheless be in optical contact with the light-guiding film, such that the electrodes will interact with the light propagating within the light-guiding film.

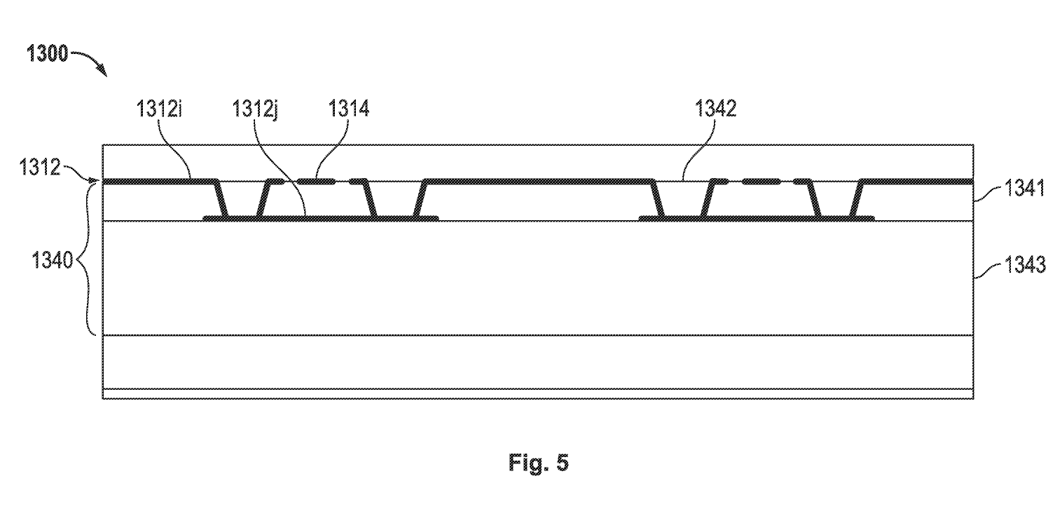

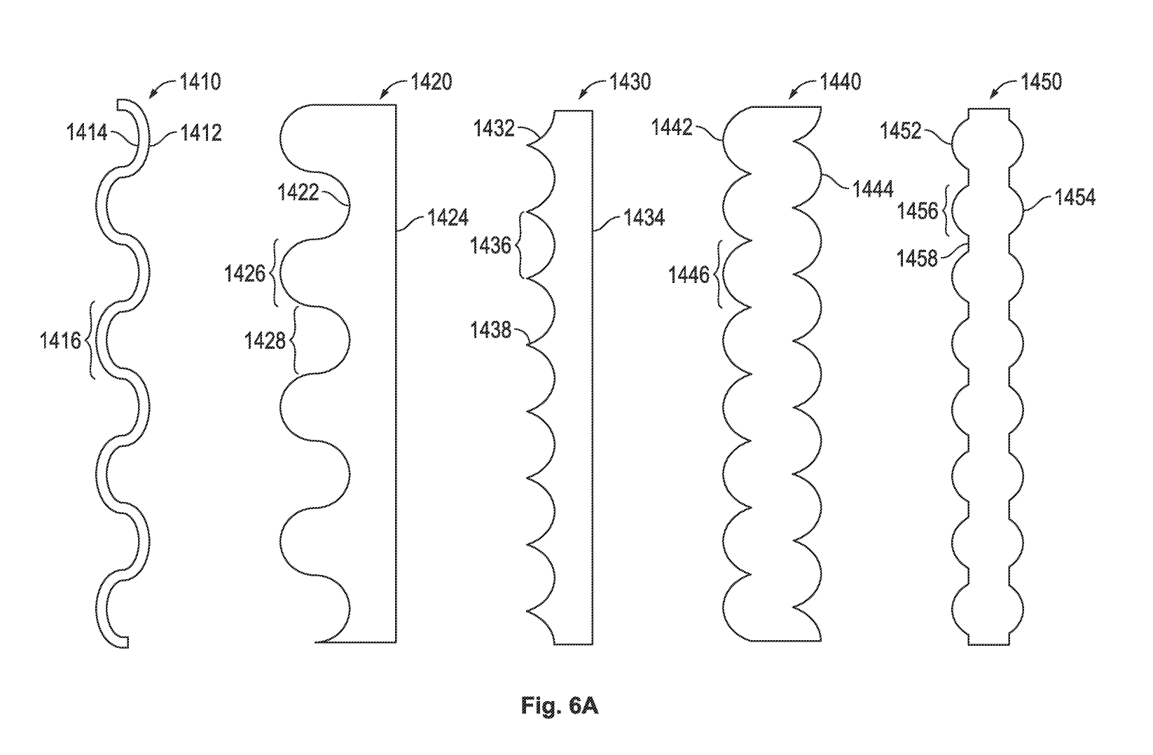

FIG. 5 shows a cross-sectional view of an example of a display device including a PCT sensor and a light-guiding film in optical contact with the components of the PCT sensor. The display device 1300 includes a light-guiding layer 1340 formed by bringing a first light-guiding sublayer 1341 into contact with a second light-guiding sublayer 1343. Electrodes 1312 and 1314 oriented generally orthogonal to one another are disposed on or adjacent the surface of first light-guiding sublayer 1341, and jumpers 1312j connect portions 1312i of electrode 1312 while maintaining electrical isolation of electrodes 1312 and 1314. Electrodes 1312 extend generally parallel to the plane of the page, while electrodes 1314 extend generally orthogonal to the plane of the page. The jumpers 1312j may be disposed on or adjacent a surface of second light-guiding sublayer 1343. As discussed above, portions of the electrodes 1312 and 1314 may be formed from an interferometric stack of layers, or may include an alternate opaque or masking layer.

The light-guiding layer 1340 may also include a plurality of light-turning features such as the light turning features 1250 of FIGS. 4A, 4C, and 4D (not shown in FIG. 5) disposed along an upper surface 1342 of the light guiding layer 1340 which include reflective surfaces oriented at an angle to the major surfaces of light-guiding layer 1340, such as upper surface 1342. These light-turning features will redirect light propagating within the light-guiding layer 1340 to eject the light out of the lower surface 1346 of the light-guiding layer 1340 and towards a reflective display 1350 disposed on the opposite surface of a light-transmissive display substrate 1352. The reflective light will illuminate the reflective display 1350 and then be redirected back through the light-guiding layer 1340 of the frontlight system, through the display glass 1360 and any additional layers within the display device towards a viewer.

Because the electrodes 1312 and 1314 are disposed on or adjacent the light-guiding layer 1340, the light propagating within the light-guiding layer 1340 will interact with these sets of electrodes. In the implementations discussed above, the electrodes within the PCT sensor have been illustrated as generally linear. When a plurality of generally linear electrodes are in optical contact with a light-guiding layer, light injected into the light-guiding layer will interact with the plurality of linear electrodes to generate an optical effect which can be perceived by a viewer, even if the thicknesses of the individual electrodes are sufficiently thin that they cannot be readily perceived by a viewer. This optical effect is generally present only when light is being injected into the light-guiding layer, and may not occur when light is not being injected into the light-guiding layer 1340, or when the light-guiding layer 1340 is optically isolated from the electrodes 1312 and 1314.

In some implementations, the generation of this distinctive optical effect can be avoided by the use of electrodes having shapes which are at least partially nonlinear. An electrode which is at least partially nonlinear may have an edge having a length which is longer than a direct end-to-end distance of the electrode. The use of electrodes having a shape which is non-linear on only one major edge has been shown to avoid the generation of this distinctive optical effect when the electrode is in optical contact with an active light-guiding layer, even when the opposing major edge of the electrode is linear in shape.

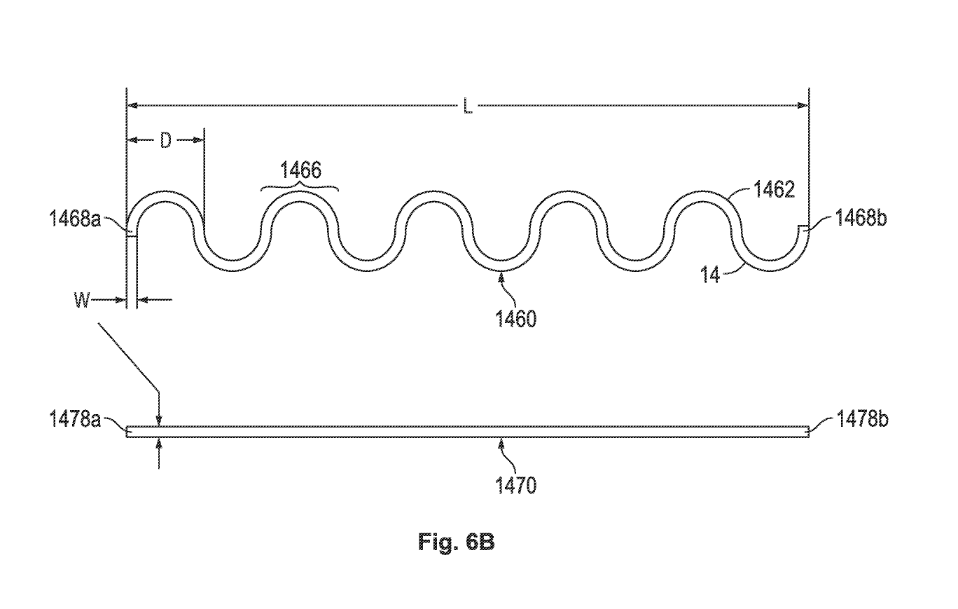

FIG. 6 shows multiple examples of non-linear electrode shapes which can be used to prevent the generation of a distinctive optical effect when in optical contact with an active light-guiding layer. In particular, FIG. 6 shows five examples of wiring 1410, 1420, 1430, 1440, and 1450 which is at least partially non-linear.

Wiring 1410 has a substantially constant thickness, but a periodic curved shape. The curved shape of wiring 1410 is defined by two substantially parallel edges 1412 and 1414 which form a plurality of arc-shaped sections 1416 of alternating orientation along the length of wiring 1410. The periodic curved shape may be, for example, a sinusoidal shape, or a series of substantially semicircular or semi-elliptical shapes.

Wiring 1420 has a varying thickness over the length of the wiring 1420 and includes a curved edge 1422 and a substantially linear edge 1424. The wiring 1420 thus includes outwardly-bulging sections 1426 separated by thinner convex regions 1428.

Wiring 1430 also has a varying thickness over the length of the wiring 1430, and includes a substantially linear edge 1434 and a curved edge 1432 which define a series of concave regions 1436. In contrast to wiring 1410 and wiring 1420, the series of concave regions 1436 form narrowly tapering points 1438 therebetween.

Wiring 1440 has a smaller variation in thickness over the length of the wiring 1440 than wiring 1420 and 1430. Curved edges 1442 and 1444 comprise a series of semicircular shapes 1446, and the semicircular shapes 1446 of curved edges 1442 are longitudinally offset from the semicircular shapes 1446 of curved edges 1442. In particular, in the illustrated implementation, the semicircular shapes 1446 are longitudinally offset by a distance equal to half of their length, or half of the period of the curved shape, forming a symmetrical serpentine shape. Other non-symmetrical offsets may be used in other implementations, increasing the variance in thickness across the length of the wiring 1440. In other implementations, the curved shapes may not be semicircular, but may be semi-elliptical shapes or other arc-shaped features.

Wiring 1450 has a varying thickness over the length of the wiring, and includes symmetrical curved edges 1452 and 1454. Similar to wiring 1440, the curved edges 1452 and 1454 include a plurality of arc-shaped sections 1456, but the arc-shaped sections 1456 on opposite edges 1452 and 1454 are not laterally offset from one another, such that the curved edges 1452 and 1454 are generally symmetric. It can also be seen that the wiring 1450 includes some linear sections 1458 on each of the curved edges 1452 and 1454.

A wide variety of other non-linear wiring shapes may be used in order to avoid an undesirable optical effect when the wiring is in optical contact with light propagating within a light-guiding layer. The above wiring examples 1410, 1420, 1430, 1440, and 1450 illustrate a non-exhaustive number of different shapes which may be incorporated into non-linear wiring. In some implementations, so long as a sufficient portion of an edge of non-linear wiring has a non-zero curvature, the remaining linear portions will not generate the undesirable optical effects when in optical contact with a light guide. For example, in some implementations, at least 90% of the length of the non-linear edge of the wiring has a non-zero curvature, while in further implementations, at least 95% of the length of the non-linear edge of the wiring has a non-zero curvature. If wiring comprises a series of linear portions, such as a zig-zag shape, the substantial linearity of the individual portions may not prevent the generation of the undersirable optical effects.

FIG. 6B shows an example of a comparison between a non-linear electrode shape and a similarly dimensioned linear electrode shape. In particular, non-linear wiring 1460 is similar to wiring 1410, and includes a plurality of generally semicircular portions 1466. Curved edges 1462 and 1464 are generally parallel to one another.

The outer diameter D of the semicircular portions 1466 may be used as a characteristic dimension in order to provide an indication of the shape of the wiring 1460. The shape of the wiring 1460 in the (x,y) plane is also controlled in part by the width W of the wiring 1460, which in the illustrated implementation remains substantially constant over the length of the wiring 1460, as measured in a plane perpendicular to the curved path of the electrode at each point along the curved path. For example, the outer diameter D controls the period of the periodic shape of the wiring 1460, and the ratio D/W of the outer diameter D to width W controls the overall shape of the wiring 1460. Where the outer diameter D is substantially larger than the width W, the appearance of the wiring 1460 will be similar to that depicted in wiring 1460 or wiring 1460, with a thin serpentine appearance. As W approaches D, the wiring 1460 may become more similar in appearance to that of wiring 1440.

The wiring 1460 extends from a first end 1468a to a second end 1468b separated by a length L. Similarly, linear wiring 1460 which has a width W equal to the width of wiring 1460 extends from a first end 1478a to a second end 1478b which are also separated by the same length L. In the illustrated implementation, the total surface area of non-linear wiring 1460 is greater than the total surface area of linear wiring 1470 of equal length and width. The ratio D/W provides an indication of the difference in surface area between non-linear wiring and linear wiring of equivalent length and widths.

TABLE 1

| D/W Ratio | Area Ratio |
|---|---|
| 2 | 1.05 |
| 3 | 1.26 |
| 4 | 1.35 |
| 5 | 1.40 |
| 10 | 1.49 |
| 15 | 1.52 |
| 20 | 1.53 |

Table 1 illustrates the area ratio of surface area of non-linear wiring to surface area of linear wiring of equivalent length and width. For very large values of D/W, the area ratio approaches π/2. However, as the D/W ratio decreases and approaches lower values, particularly as it approaches 2, the area ratio of the surface area of non-linear wiring 1460 to the surface area of linear wiring 1470 approaches 1. If the D/W ratio of non-linear wiring 1460 were decreased to 2, the wiring 1460 would essentially consist of a series of facing semicircles laterally offset from one another, much like wiring 1440 of FIG. 6A but without the central portion of constant width.

The difference in surface area between non-linear wiring 1460 with a D/W ratio of 2 and linear wiring 1470 is roughly 5%. Non-linear wiring with low values of D/W can thus prevent the creation of undesirable optical effects without significantly increasing the surface area of the wiring, minimizing the overall visual effect of the use of non-linear wiring. In some implementations, the D/W ratio is selected to be less than 50, while in further implementations D/W can be less than 20, less than 5, or less than 3.

Direct constraints may also be placed on D or W, respectively, in some implementations. For example, D may be constrained at least in part by the pixel size within a display, such that the characteristic distance D is substantially equal to or less than the width of a pixel or other display element within the display, and may in some particular implementations be less than 250 μm, less than 150 μm, less than 100 μm, less than 50 μm, or less than 10 μm. Similarly, in some implementations, W may be less than 10 μm, less than 5 μm, or less than 3 μm.

It can also be seen that the length of each of the non-linear edges 1462 and 1464 of wiring 1460 is substantially larger than the distance L between the first end 1468a and second end 1468b of wiring 1460 (and between the first end 1478a and second end 1478b of linear wiring 1470). In some implementations in which the shape of the curved portions are semicircular, the ratio of the length of the edges 1462 and 1464 of the wiring 1460 to the distance L between the 1468a and 1468b of the wiring 1460 can approach π/2. In other implementations, the ratio of the length of a non-linear edge to the distance L can be greater or less than π/2, depending on the shape of the wiring, For example, in some implementations, this ratio may be greater than 1.25.

In other implementations, characteristic dimensions D may be defined for other shapes formed in the edges of the electrode. For example, in an implementation in which the shape of the electrode includes a regular oscillation or periodic variation in shape, the characteristic dimension D may be defined as the distance between peaks. In an implementation in which the shape of the electrode includes an irregular oscillation or variation, such as semicircular shapes of varying size, the characteristic dimension D may be defined as an average distance between peaks. Similarly, in implementations in which the width W of the electrode varies over the length of the electrode, an average width W or other characteristic width may be used to provide an indication of the total surface area of the nonlinear electrode. The ratio between a characteristic dimension D and a width W may provide a metric for designing non-linear wiring shapes to avoid undesirable optical effect without increasing the total surface area of the electrodes beyond a desired percentage. Generally, minimizing the width variation in a plane perpendicular to a straight line extending between the ends of the nonlinear electrode can minimize the increase in surface area as compared to a linear electrode extending between the same points. In some implementations, the total area of a non-linear electrode may be constrained to be less than twice the area of a linear electrode with the same average width, and in further implementations, total area may be constrained to be less than 1.5 times or less than 1.3 times the area of a linear electrode with the same average width.

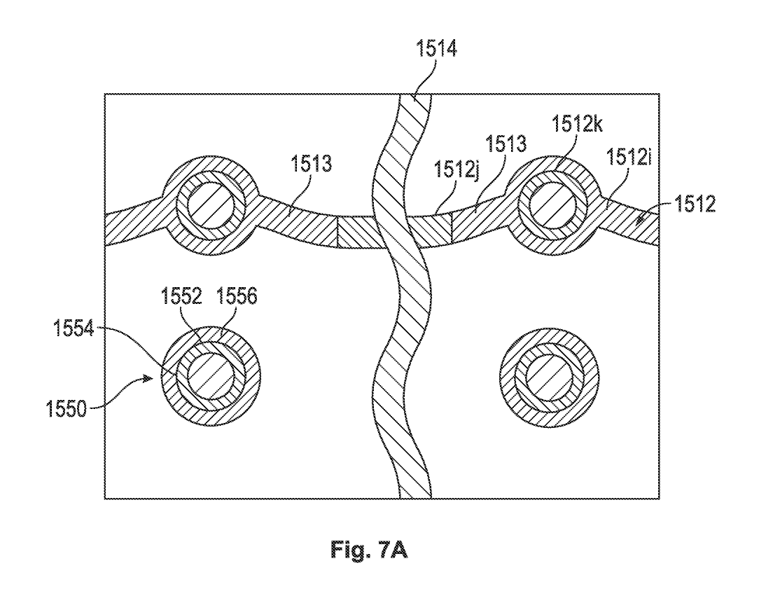

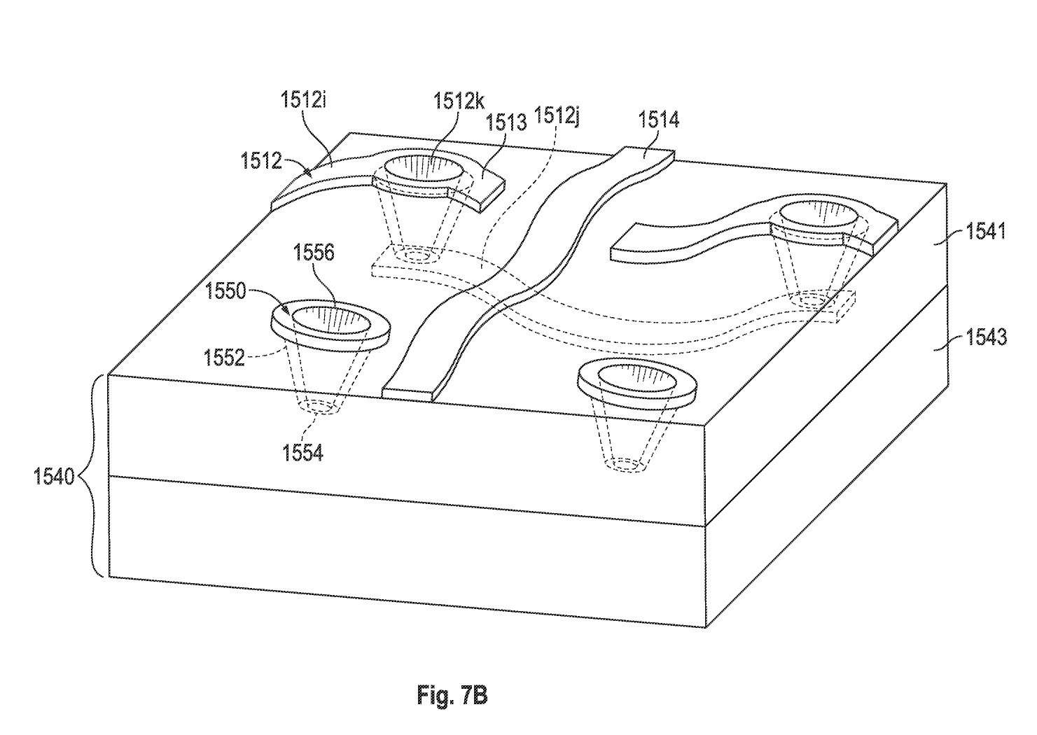

FIG. 7A shows a top view of an example of an intersection of a PCT sensor utilizing non-linear electrodes. Both the column electrode 1514 and the various components of the row electrode 1512 other than rounded connection portion 1512k are illustrated as having similar generally sinusoidal shapes, with substantially parallel curved edges, similar in shape to the wiring 1410 of FIG. 6A. In some implementations, portions of the row electrode 1512 such as the underlying jumper portion 1512j passing beneath column electrode 1514 may not be aligned with the overlying portion 1512i of the row electrode 1512 as shown. In some implementations, certain components of the row electrode 1512 such as the underlying jumper portion 1512j or the connection portion 1512k may be substantially linear or have a different non-linear shape. As discussed above, portions of the electrodes 1512 and 1514 may be formed from an interferometric stack of layers, or may include an alternate opaque or masking layer. For example, at least electrode 1514, coplanar electrode portions 1512i, connector portions 1512k and light-shielding extensions 1513 may be formed from the same stack of materials, and each of these structures may in some implementations comprise an interferometric film stack such as those discussed above with respect to FIGS. 4A-4D.

In addition, the illustrated implementation of sensor 1500 includes non-linear shielding structures 1513 extending inwardly towards column electrode 1513 from the adjacent ends of row electrode 1512i and connecting portion 1512k, However, other implementations may include no shielding structures, shielding structures of a different size or shape, such linear shielding structures, or shielding structures in a different location, such as extending from the column electrode 1514 or disconnected from both the column electrode 1514 and the row electrode 1512. FIG. 7A also includes light-turning structures 1550 which are similar in shape to the light-turning structures 1250 of FIG. 4A. These light-turning structures 1250 may be formed from the same layer or stack of materials as electrode 1514, coplanar electrode portions 1512i, connector portions 1512k and light-shielding extensions 1513, and in some implementations, all of these components may be patterned in a single step.

FIG. 7B shows a perspective view of top perspective view of the intersection of the PCT sensor of FIG. 7A. It can be seen that the components of sensor 1500 are in the illustrated implementation disposed within or adjacent a light-guiding layer 1540. The light-guiding layer 1540 includes at least a first light-guiding sublayer 1541 and a second light-guiding sublayer 1543 coupled to the first light-guiding sublayer 1541. The column electrode 1514 and the coplanar portions 1512i of the row electrodes 1512 may be disposed on or adjacent the upper surface 1542 of the light-guiding layer 1540. The jumper portions 1512j of the row electrodes 1512 may be disposed on or adjacent the upper surface of the second light-guiding sublayer 1543, such that a portion of the row electrodes is disposed within the light guiding layer 1540. The circular vias of connection portions 1512k and the tapered sidewalls 1552 of light-turning features 1550 extend through the first light-guiding sublayer 1541, and are similar in shape to one another, both having an inverted frustroconical shape.

In the illustrated implementation, each of electrodes 1512 and 1514 is in optical contact with the light-guiding layer 1540, and will interact with light propagating therein. Because of the nonlinear shape of at least a portion of the electrodes 1512 and 1514, undesirable optical effects may be avoided when the light-guiding layer 1540 is active, and light is being injected into the light-guiding layer 1540 from a light source (not shown). In other implementations, layers may be disposed between the electrodes 1512 and 1514, and the electrodes 1512 and 1514 may not be in direct physical contact with the light-guiding layer 1540. However, so long as the electrodes 1512 and 1514 or a portion thereof are in optical contact with the light-guiding layer, undesirable optical effects can be generated if the electrodes 1512 and 1514 have a linear or substantially linear shape. By using electrodes having a non-linear shape whenever the electrodes are in optical contact with a light-guiding layer, generation of these undesirable effects can be avoided.

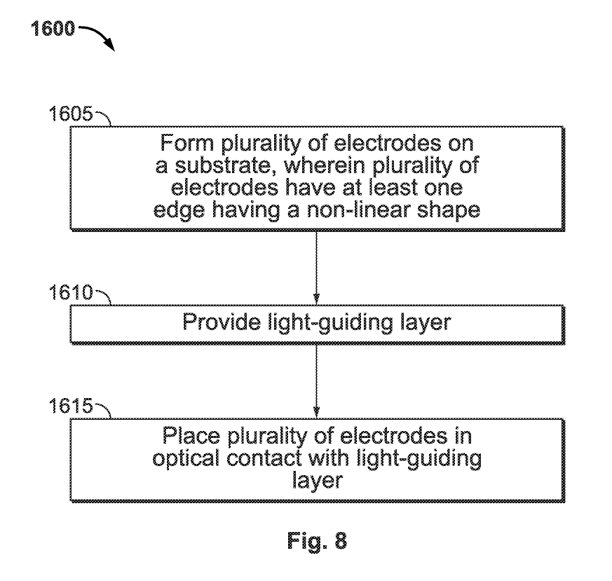

FIG. 8 shows an example of a flow diagram illustrating a manufacturing process for a device including a plurality of electrodes with at least one non-linear edge. The method 1600 begins at a block 1605 wherein a plurality of electrodes are formed on a substrate, wherein the plurality of electrodes include at least one edge having a non-linear shape. As discussed above, a wide variety of non-linear shapes may be used, and the

The method 1600 moves to a block 1610 where a light-guiding layer is provided. In some implementations, the light-guiding layer may be configured to receive light injected through an edge of the light-guiding layer and generally constrain propagation of light therein. The light-guiding layer may also include light-turning features configured to redirect light so that it is ejected out of the light-guiding layer, and towards a structure to be illuminated such as a reflective display.

The method 1600 moves to a block 1615 where the plurality of electrodes are placed in optical contact with the light-guiding layer. In some implementations, the plurality of electrodes may be placed in optical contact with the light-guiding layer without being placed in direct physical contact with the light-guiding layer. In other implementations, the electrodes may directly contact or even be disposed within the light-guiding layer. In some implementations, this process can be used to form a PCT sensor in a device which is illuminated by a frontlight system incorporating the light-guiding layer, although other suitable devices may also be formed by this method.

The blocks of method 1600 are merely exemplary, and implementations of various manufacturing processes may perform the steps discussed above in a different order, may include additional steps, or may omit certain steps, or may combine steps illustrated as separate blocks in FIG. 8. For example, in some implementations, as discussed herein, the substrate may be a provided light-guiding layer or a layer which will form a part of a light-guiding layer. In such an implementation, formation of a plurality of electrodes on such a layer will simultaneously place the plurality of electrodes in optical contact with a light-guiding layer.

In a particular variation, jumper portions can be formed on an upper surface of a light-guiding sublayer, and a second light-guiding sublayer may be formed over the first light-guiding sublayer and the jumper portions formed thereon. Tapered apertures corresponding to the locations of both circular vias exposing portions of the jumper portions and of separate light-turning features are then formed through the second-light-guiding sublayer. In some implementations, a first portion of these tapered apertures expose a portion of an underlying jumper portion, and a second portion of these tapered apertures are not located over a jumper portion. Finally, a stack of layers may be deposited and patterned to form both continuous electrodes and coplanar electrode portions, as well as to form connecting portions within the first portion of the tapered apertures, placing the coplanar electrode portions in contact with underlying jumper portions.

The combination of coplanar electrode portions, connecting portions, and jumper portions may form row electrodes extending across the light guiding layer, and electrodes extending generally perpendicular to the row electrodes may form column electrodes. At least a portion of the row and column electrodes may include at least one edge having a non-linear shape, as discussed above. Simultaneously with patterning the stack of layers to form at least a portion of the row and column electrodes, the stack of layers may also be patterned to form other structures, such as light-shielding extensions located over at least a portion of the jumper portions, and light-turning features located at least partially within the second portion of the tapered apertures, so that they will be located generally away from the electrodes, as discussed above.

As discussed above, implementations such as those described above can be used in conjunction with a display device, which may include an EMS or MEMS device or apparatus. An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

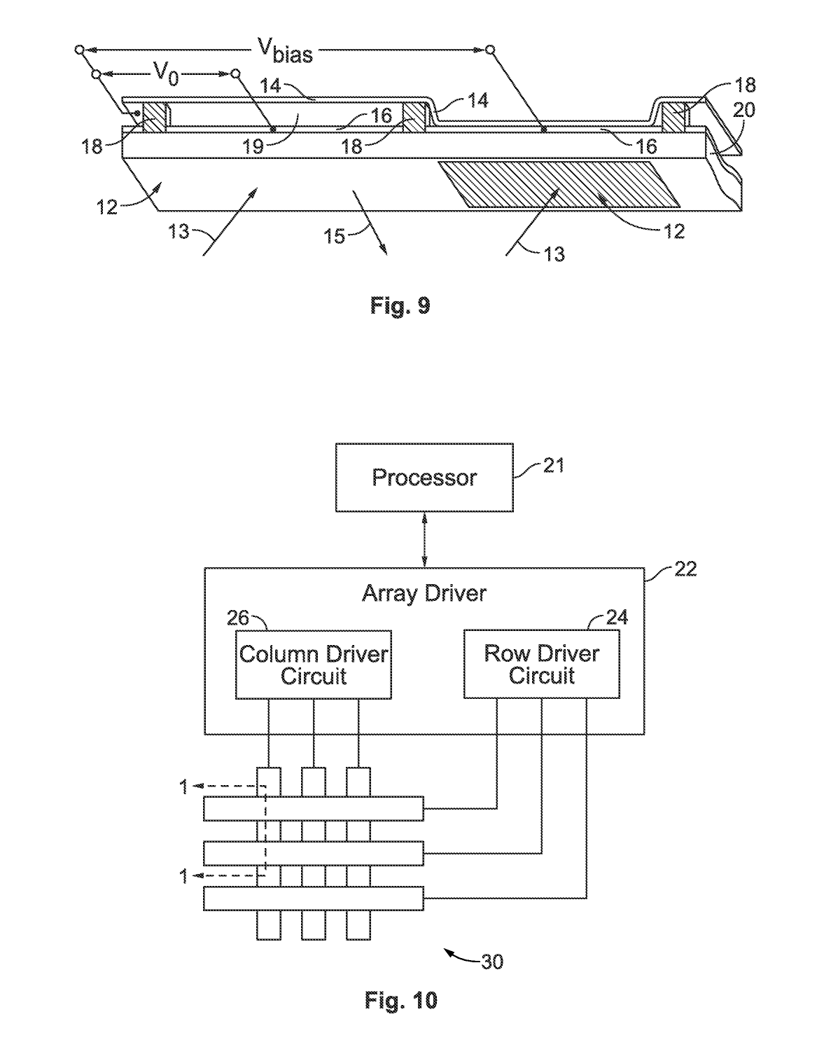

FIG. 9 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 9 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 9, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 9 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 9, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 9. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 10 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 9 is shown by the lines 1-1 in FIG. 10. Although FIG. 10 illustrates a 3×3 array of IMOD display elements for the sake of clarity, the display array 30 may contain a very large number of IMOD display elements, and may have a different number of IMOD display elements in rows than in columns, and vice versa.

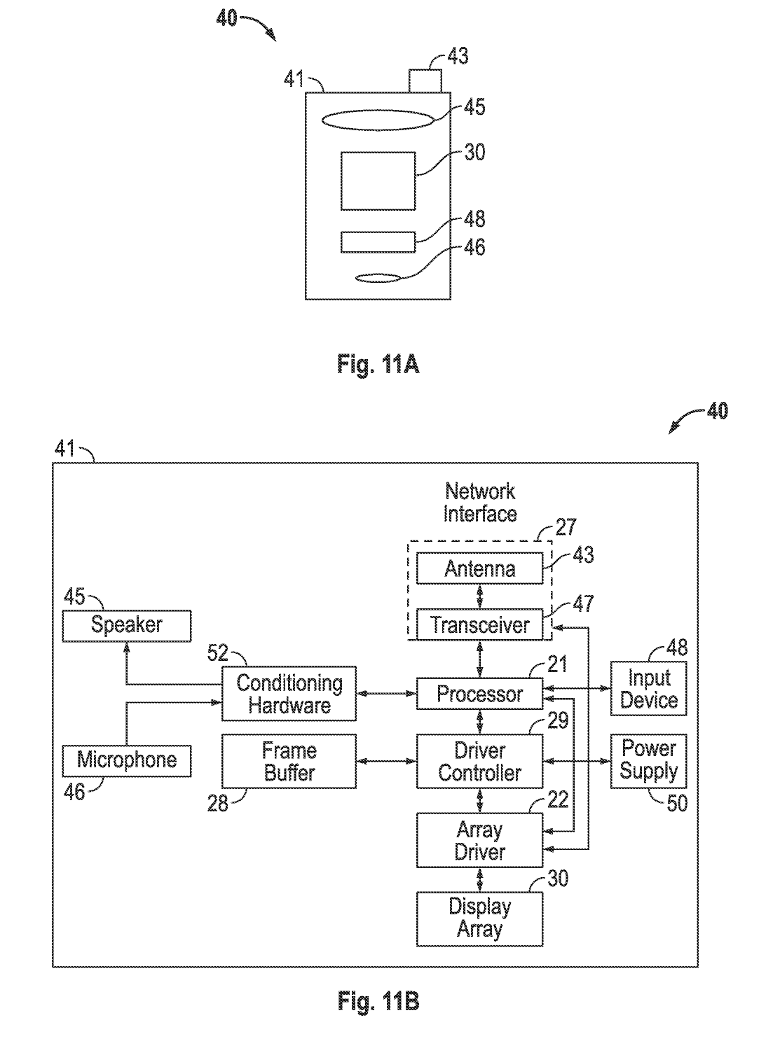

FIGS. 11A and 11B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 11A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device, comprising:
a light-guiding layer, wherein the light-guiding layer is configured to constrain light propagating therein; and
a plurality of electrodes in optical contact with the light-guiding layer, wherein the plurality of electrodes include at least one edge having a non-linear shape.

2. The device of claim 1, wherein one of the plurality of electrodes extends from a first point to a second point, and wherein the length of the at least one edge having a non-linear shape is longer than the distance between the first point and the second point.

3. The device of claim 2, wherein the at least one edge having a non-linear shape comprises a non-zero curvature along at least 90% of the length of the edge.

4. The device of claim 3, wherein the at least one edge having a non-linear shape comprises a non-zero curvature along at least 95% of the length of the edge.

5. The device of claim 2, wherein the length of the at least one edge having a non-linear shape is at least 25% longer than the distance between the first point and the second point.

6. The device of claim 2, wherein:
the distance between the first point to the second point is given by L;
the one of the plurality of electrodes has an average width W over its length; and
the total area of the one of the plurality of electrodes is less than twice the product of L and W.

7. The device of claim 6, wherein the total area of the one of the plurality of electrodes is less than 1.5 times the product of L and W.

8. The device of claim 1, wherein:
the non-linear edge has a characteristic dimension given by D indicative of the shape of the plurality of electrodes;
at least one of the plurality of electrodes has an average width over its length given by W; and
the ratio D/W is selected to be less than 20.

9. The device of claim 8, wherein the ratio D/W is selected to be less than 5.

10. The device of claim 8, wherein the non-linear edge includes a plurality of semicircular arcs, and wherein the characteristic dimension D is the outer diameter of the semicircular arcs.

11. The device of claim 8, wherein the non-linear edge includes an oscillating shape comprising a plurality of peaks, and wherein the characteristic dimension D is the average distance between peaks.

12. The device of claim 1, wherein the non-linear edge has a characteristic dimension given by D indicative of the shape of the plurality of electrodes, and wherein the characteristic dimension D is less than about 250 μm.

13. The device of claim 12, wherein the characteristic dimension D is less than about 100 μm.

14. The device of claim 12, wherein the characteristic dimension D is less than about 50 μm.

15. The device of claim 12, wherein the characteristic dimension D is less than about 10 μm.

16. The device of claim 1, wherein the width of the plurality of electrodes remains substantially constant along their lengths.

17. The device of claim 1, wherein the width of the plurality of electrodes varies along their lengths.

18. The device of claim 1, wherein the plurality of electrodes also include at least a second edge having a non-linear shape.

19. The device of claim 18, wherein the first and second edges extend substantially parallel to one another.

20. The device of claim 1, wherein the at least one edge having a non-linear shape includes a substantially periodic shape.

21. The device of claim 1, wherein the plurality of electrodes include an absorber layer, a spacer layer disposed between the absorber layer and the light-guiding layer, and a reflective layer disposed between the spacer layer and the light-guiding layer.

22. The device of claim 1, additionally including a reflective display disposed on the opposite side of the light-guiding layer as the plurality of electrodes, wherein the light-guiding film includes light-turning features configured to redirect light propagating within the light-guiding layer towards the reflective display.

23. The device of claim 22, wherein the reflective display includes a plurality of display elements and the non-linear edge includes an oscillating shape comprising a plurality of peaks, wherein a characteristic dimension D is defined as the average distance between peaks, and wherein the characteristic dimension D is substantially equal to or less than a width of one of the plurality of display elements.

24. The device of claim 22, further comprising:
a processor that is configured to communicate with the reflective display, the processor being configured to process image data; and
a memory device that is configured to communicate with the processor.

25. The device of claim 24, further comprising:
a driver circuit configured to send at least one signal to the reflective display; and
a controller configured to send at least a portion of the image data to the driver circuit.

26. The device of claim 24, further comprising an image source module configured to send the image data to the processor, wherein the image source module includes at least one of a receiver, transceiver, and transmitter.

27. The device of claim 24, further comprising an input device configured to receive input data and to communicate the input data to the processor.

28. A device, comprising:
a light-guiding layer, wherein the light-guiding layer is configured to constrain light propagating therein; and
a plurality of electrodes in optical contact with the light-guiding layer, wherein the plurality of electrodes include means for minimizing undesirable optical effects when light is propagating within the light-guiding layer.

29. The device of claim 28, wherein the minimizing means comprise at least one edge having a non-linear shape.

30. A method of fabricating a device, comprising:
forming a plurality of electrodes on a substrate, wherein the plurality of electrodes include at least one edge having a non-linear shape;
providing a light-guiding layer configured to constrain light propagating therein; and
placing the plurality of electrodes in optical communication with the light-guiding layer.

31. The method of claim 30, wherein forming a plurality of electrodes on a substrate and placing the plurality of electrodes in optical communication with the light-guiding layer comprises forming at least a portion of the plurality of electrodes on a surface of the light-guiding layer.

32. The method of claim 30, wherein one of the plurality of electrodes extends from a first point to a second point, and wherein the length of the at least one edge having a non-linear shape is longer than the distance between the first point and the second point.

33. The method of claim 31, wherein:
the distance between the first point to the second point is given by L;
the one of the plurality of electrodes has an average width W over its length; and
the total area of the one of the plurality of electrodes is less than twice the product of L and W.

34. The method of claim 30, wherein:
the non-linear edge has a characteristic dimension given by D indicative of the shape of the plurality of electrodes;
at least one of the plurality of electrodes has an average width over its length given by W; and
the ratio D/W is selected to be less than 20.

35. The method of claim 34, wherein the ratio D/W is selected to be less than 5.

36. A method of fabricating a device, comprising:
forming a plurality of jumper portions on a surface of a first light-guiding layer;
disposing a second light-guiding sublayer over the first light-guiding sublayer, wherein the second light-guiding sublayer includes a plurality of tapered apertures extending therethrough, and wherein at least a first portion of the tapered apertures expose a portion of an underlying jumper portion.
depositing at least one layer over the second light-guiding layer; and
patterning the at least one layer to form a plurality of electrodes at least partially disposed on the surface of the patterned second light-guiding layer, wherein the plurality of electrodes include at least one edge having a non-linear shape.

37. The method of claim 36, wherein disposing a second light-guiding sublayer over the first light-guiding sublayer comprises forming a second light-guiding sublayer over the first light-guiding sublayer and patterning the second-light guiding layer to form a plurality of tapered apertures in the second-light guiding layer.

38. The method of claim 36, wherein a second portion of the tapered apertures formed in the second light-guiding layer do not expose a portion of an underlying jumper portion, wherein patterning the at least one layer to form a plurality of electrodes further comprises patterning the at least one layer to form a plurality of light-turning features at least partially disposed within the second portion of the tapered apertures.

39. The method of claim 36, wherein depositing at least one layer over the patterned second light-guiding layer includes depositing a stack of layers over the patterned second light-guiding layer, the stack of layers including a reflective layer, depositing a spacer layer over the reflective layer, and depositing an absorber layer over the spacer layer.

40. The method of claim 36, wherein the jumper portions are substantially linear.
